(19) United States
(12) Patent Application Publication
(10) Pub. No.: US 2025/0085186 A1
(43) Pub. Date: Mar. 13, 2025

(54) METHOD AND SYSTEM FOR QUANTITATIVE DAMAGE MONITORING OF REINFORCED CONCRETE STRUCTURE

(71) Applicant: SHENZHEN UNIVERSITY, Shenzhen, Guangdong (CN)

(72) Inventors: Yingwu ZHOU, Shenzhen, Guangdong (CN); Zenghui YE, Shenzhen, Guangdong (CN); Xiaoxu HUANG, Shenzhen, Guangdong (CN); Feng XING, Shenzhen, Guangdong (CN); Zongjun LI, Shenzhen, Guangdong (CN); Zhongfeng ZHU, Shenzhen, Guangdong (CN); Menghuan GUO, Shenzhen, Guangdong (CN)

(73) Assignee: SHENZHEN UNIVERSITY, Shenzhen, Guangdong (CN)

(21) Appl. No.: 18/701,093

(22) PCT Filed: Aug. 31, 2023
(86) PCT No.: PCT/CN2023/116214

§ 371 Date: Apr. 12, 2024

(30) Foreign Application Priority Data
Aug. 31, 2023 (CN) 202211053057.9

(51) Int. Cl. G01M 5/00; G01L 1/24

(52) U.S. Cl. CPC G01M 5/0033; G01L 1/242; G01M 5/0091

(57) ABSTRACT

The present disclosure relates to a method and system for quantitative damage monitoring of a reinforced concrete structure and belongs to the technical field of civil engineering. The method includes: obtaining an optical fiber strain signal and cross-section design parameters of a longitudinal tensile reinforcement of a reinforced concrete beam (101), where the cross-section design parameters include geometric parameters and material performance parameters; the geometric parameters include a cross-section width, a cross-section height, an equivalent cross-section height, a protective layer thickness, and a reinforcement area; establishing a cross-section analysis model based on the cross-section design parameters (102), where the cross-section analysis model includes a concrete damage stress-strain relationship model and a reinforcement damage stress-strain relationship model; and inputting the optical fiber strain signal to the cross-section analysis model to obtain a damage indicator and a bending moment-curvature curve of each cross-section (103).

This patent application claims the benefit and priority of Chinese Patent Application 202211053057.9 filed with the China National Intellectual Property Administration on Aug. 31, 2022 and entitled “METHOD AND SYSTEM FOR QUANTITATIVE DAMAGE MONITORING OF REINFORCED CONCRETE STRUCTURE”, the disclosure of which is incorporated by reference herein in its entirety as part of the present application.

### TECHNICAL FIELD

The present disclosure relates to the technical field of civil engineering, and in particular, to a method and system for quantitative damage monitoring of a reinforced concrete structure.

### BACKGROUND

A reinforced concrete (RC) structure has the characteristics of firmness, durability, good fire resistance, low construction cost, and the like, and is a structure form used extensively at present. Many important infrastructures are built with RC structures, such as ports, bridges, and airports. An RC structure may be subjected to extreme loads such as earthquake, impact, explosion, and typhoon repeatedly within a design reference period. Real-time quantitative damage monitoring carried out for an important RC structure is conducive to accurate determination on the performance degradation of the structure, providing reference for first-aid repair and structural restoration. It is thus necessary and of great significance to quantitatively monitor structural damage caused by various complex loads.

The damage of a beam column under the action of a load is distinguished between apparent damage and internal damage. For the apparent damage, a degree of the damage may be determined using naked eyes. However, the internal damage can be hardly distinguished by naked eyes. Furthermore, due to the uncertainty of a load, cross-section damage has damage degree uncertainty and damage distribution uncertainty. At present, there has been a mature theory for quantitative analysis of the cross-section damage, which mainly involves performing quantitative analysis on the cross-section damage by a cross-section analysis method. A distributed optical fiber sensor has a huge application potential in structure health monitoring for its characteristics such as low weight, high accuracy, high sensitivity, and anti-interference performance. However, it can only detect the strain of a particular component of a structure and cannot perform quantitative monitoring and assessment on the damage of the structure.

### SUMMARY

An objective of the present disclosure is to provide a method and system for quantitative damage monitoring of a reinforced concrete structure to solve the problem that a structural damage analysis method in the prior art cannot realize quantitative monitoring and assessment on the damage of a structure.

To achieve the above objective, the present disclosure provides the following solution:

A method for quantitative damage monitoring of a reinforced concrete structure includes:
obtaining an optical fiber strain signal and cross-section design parameters of a longitudinal tensile reinforcement of a reinforced concrete beam, where the cross-section design parameters include geometric parameters and material performance parameters; the geometric parameters include a cross-section width, a cross-section height, an equivalent cross-section height, a protective layer thickness, and a reinforcement area; and the material performance parameters include a compression peak stress of concrete, an initial tangent modulus of concrete, and an initial tangent modulus of a reinforcement;
establishing a cross-section analysis model based on the cross-section design parameters, where the cross-section analysis model includes a concrete damage stress-strain relationship model and a reinforcement damage stress-strain relationship model; and
inputting the optical fiber strain signal to the cross-section analysis model to obtain a damage indicator and a bending moment-curvature curve of each cross-section.

Optionally, the inputting the optical fiber strain signal to the cross-section analysis model to obtain a damage indicator and a bending moment-curvature curve of each cross-section specifically includes:
setting a position of a neutral axis of an xth cross-section at a time t as y_{0,x}(t);
calculating, based on the cross-section design parameters, the optical fiber strain signal, and the position of the neutral axis, a curvature of the xth cross-section at the time t by a formula ϕₓ(t)=ε_{s,x}(t)/(y_{0,x}(t)−d), where ϕₓ(t) represents the curvature of the xth cross-section at the time t; ε_{s,x}(t) represents the optical fiber strain signal; and d represents the equivalent cross-section height;
calculating, based on the curvature, a strain distribution of concrete fibers of the xth cross-section at the time t and a strain distribution of compressive reinforcement fibers of the xth cross-section at the time t;
calculating, based on the strain distribution of the concrete fibers of the xth cross-section at the time t, a stress distribution and a damage indicator of the concrete fibers of the xth cross-section at the time t using the concrete damage stress-strain relationship model;
calculating, based on the strain distribution of reinforcement fibers of the xth cross-section at the time t, a stress distribution and a damage indicator of the reinforcement fibers of the xth cross-section at the time t using the reinforcement damage stress-strain relationship model, where the strain distribution of the reinforcement fibers of the xth cross-section at the time t includes a strain distribution of tensile reinforcement fibers of the xth cross-section at the time t and the strain distribution of the compressive reinforcement fibers of the xth cross-section at the time t;
calculating a resultant force of axial forces based on the stress distribution and the damage indicator of the concrete fibers of the xth cross-section at the time t and the stress distribution and the damage indicator of the reinforcement fibers of the xth cross-section at the time t;
determining whether the resultant force of the axial forces is zero;
if the resultant force of the axial forces is zero, calculating and outputting the damage indicator and the bending moment-curvature curve of the xth cross-section at the time t; and
if the resultant force of the axial forces is not zero, returning to “setting a position of a neutral axis of the xth cross-section at a time t as y_{0,x}(t)”.

Optionally, the calculating a resultant force of axial forces based on the stress distribution and the damage indicator of the concrete fibers of the xth cross-section at the time t and the stress distribution and the damage indicator of the reinforcement fibers of the xth cross-section at the time t specifically includes:
calculating the resultant force of the axial forces by the following formula:

$$\sum Nx ( t ) = {\sum }_{i = 1}^{n ( x )} ( 1 - {D}_{ci , x} ( {ε}_{ci , x} ( t ) ) ) {σ}_{ci , x} ( {ε}_{ci , x} ( t ) ) {A}_{c , i} + ( 1 - {D}_{s , x} ( {ε}_{s , x} ( t ) ) ) {σ}_{s , x} ( \text{?} ) ) {A}_{s} + ( 1 - {D}_{s , x} ( {ε}_{sc , x} ( t ) ) ) {σ}_{s , x} ( {ε}_{sc , x} ( t ) ) \text{?} ,$$

$$\text{?} \text{indicates text missing or illegible when filed}$$

where ΣNx(t) represents the resultant force of the axial forces; D_{ci,x}(ε_{ci,x}(t)) represents a damage indicator of an ith concrete fiber of the xth cross-section at the time t, and D_{s,x}(ε_{sc,x}(t)) represents a damage indicator of the compressive reinforcement fibers of the xth cross-section at the time t; D_{s,x}(ε_{s,x}(t)) represents a damage fiber of the tensile reinforcement fibers of the xth cross-section at the time t; A_{c,i}=(bh/n(x)) represents an area of the ith concrete fiber; b represents the cross-section width; h represents the cross-section height; Aₛ represents an area of the tensile reinforcement fibers; Aₛ′ represents an area of the compressive reinforcement fibers; σ_{s,x}(ε_{sc,x}(t)) represents a stress distribution of the compressive reinforcement fibers of the xth cross-section at the time t; σ_{s,x}(ε_{s,x}(t)) represents the strain distribution of the tensile reinforcement fibers of the xth cross-section at the time t; σ_{ci,x}(ε_{ci,x}(t)) represents a stress of the ith concrete fiber in the xth cross-section at the time t; and n(x) represents a number of the concrete fibers in the xth cross-section.

Optionally, the calculating the damage indicator and the bending moment-curvature curve of the xth cross-section at the time t specifically includes:
calculating the damage indicator of the xth cross-section at the time t by a formula

$${D}_{sec , x} ( t ) = 1 - \frac{A - {B}^{2} / C}{{A}^{′} - {B}^{′2} / {C}^{′}} ,$$

$$A = {\sum }_{i = 1}^{n ( x )} ( 1 - {D}_{ci , x} ( {ε}_{ci , x} ( t ) ) ) {E}_{0} {A}_{c , i} {{y}_{i , x} ( t )}^{2} + ( 1 - {D}_{s , x} ( {ε}_{s , x} ( t ) ) ) {E}_{s} \text{?} {( d - h + {y}_{0 , x} ( t ) )}^{2} + ( 1 - \text{?} ( \text{?} ( t ) ) ) {E}_{s} \text{?} {( h - \text{?} - {y}_{0 , x} ( t ) )}^{2} ,$$

$${A}^{′} = {E}_{0} {A}_{c , i} \text{?} {( t )}^{2} + {E}_{s} {{A}_{s} ( d - h + {y}_{0 , x} ( t ) )}^{2} + {E}_{s} \text{?} {( h - \text{?} - {y}_{0 , x} ( t ) )}^{2} ,$$

$$where ,$$

$$B = {\sum }_{i = 1}^{n ( x )} ( 1 - {D}_{ci , x} ( {ε}_{ci , x} ( t ) ) ) {E}_{0} {A}_{c , i} {y}_{i , x} ( t ) + ( 1 - {D}_{s , x} ( {ε}_{s , x} ( t ) ) ) \text{} \text{} {E}_{s} {A}_{s} ( d - h + {y}_{0 , x} ( t ) ) + ( 1 - \text{?} ( {ε}_{sc , x} ( t ) ) ) {E}_{s} \text{?} ( h - \text{?} - {y}_{0 , x} ( t ) ) ,$$

$$\text{?} = {E}_{0} {A}_{c , i} {y}_{i , x} ( t ) + {E}_{s} {A}_{s} ( d - h + {y}_{0 , x} ( t ) ) + {E}_{s} \text{?} ( h - \text{?} - {y}_{0 , x} ( t ) ) ,$$

$$C = {\sum }_{i = 1}^{n ( x )} ( 1 - {D}_{ci , x} ( {ε}_{ci , x} ( t ) ) ) {E}_{0} \text{?} + ( 1 - \text{?} ( {ε}_{s , x} ( t ) ) ) \text{?} + ( 1 - {D}_{s , x} ( {ε}_{sc , x} ( t ) ) ) \text{?} ,$$

$$\text{?} = {\sum }_{i = 1}^{n ( x )} {E}_{0} {A}_{c , i} + {E}_{s} {A}_{s} + {E}_{s} \text{?} ;$$

$$\text{?} \text{indicates text missing or illegible when filed}$$

D_{ci,x}(ε_{ci,x}(t)) represents the damage indicator of the ith concrete fiber of the xth cross-section at the time t; D_{s,x}(ε_{sc,x}(t)) represents the damage indicator of the compressive reinforcement fibers of the xth cross-section at the time t; D_{s,x}(ε_{s,x}(t)) represents the damage indicator of the tensile reinforcement fibers of the xth cross-section at the time t; h represents the cross-section height; Aₛ represents the area of the tensile reinforcement fibers; Aₛ′ represents the area of the compressive reinforcement fibers; σ_{s,x}(ε_{sc,x}(t)) represents the stress distribution of the compressive reinforcement fibers of the xth cross-section at the time t; σ_{s,x}(ε_{s,x}(t)) represents the strain distribution of the tensile reinforcement fibers of the xth cross-section at the time t; σ_{ci,x}(ε_{ci,x}(t)) represents the stress of the ith concrete fiber in the xth cross-section at the time t; E₀ represents the initial tangent modulus of concrete; d′ represents the protective layer thickness; Eₛ represents the initial tangent modulus of the reinforcement; A_{c,i} represents the area of the ith concrete fiber; n(x) represents the number of the concrete fibers in the xth cross-section;
calculating a bending moment Mx(t)=Mcx(t)+Msx(t) of the xth cross-section based on a sum of products of axial forces of the concrete fibers and distances of centers of the concrete fibers from the neutral axis y_{0,x}(t) and a sum of products of axial forces of the reinforcement fibers and distances of centers of the reinforcement fibers from the neutral axis y_{0,x}(t), where Mcx(t) represents a bending moment of the concrete fibers of the xth cross-section at the time t, Mcx(t)=Σᵢ₌₁^{n(x)}((1−D_{ci,x}(ε_{ci,x}(t)))σ_{ci,x}(ε_{ci,x}(t))A_{c,i}y_{i,x}(t), y_{i,x}(t) represents a distance of a center of the ith concrete fiber in the xth cross-section at the time t from the neutral axis; and Msx(t) represents a bending moment of the xth cross-section at the time t,

$$Msx ( t ) = ( 1 - {D}_{s , x} ( {ε}_{s , x} ( t ) ) ) {σ}_{s , x} ( {ε}_{s , x} ( t ) ) {A}_{s} ( d - h + {y}_{0 , x} ( t ) ) + ( 1 - {D}_{s , x} ( {ε}_{sc , x} ( t ) ) ) {σ}_{s , x} ( {ε}_{sc , x} ( t ) ) \text{?} ( h - \text{?} - {y}_{0 , x} ( t ) ) \text{?} and$$

$$\text{?} \text{indicates text missing or illegible when filed}$$

obtaining the bending moment-curvature curve based on the bending moment and the curvature.

A system for quantitative damage monitoring of a reinforced concrete structure, includes:
a data obtaining module configured to obtain an optical fiber strain signal and cross-section design parameters of a longitudinal tensile reinforcement of a reinforced concrete beam, where the cross-section design parameters include geometric parameters and material performance parameters; the geometric parameters include a cross-section width, a cross-section height, an equivalent cross-section height, a protective layer thickness, and a reinforcement area; and the material performance parameters include a compression peak stress of concrete, an initial tangent modulus of concrete, and an initial tangent modulus of a reinforcement;
a model establishment module configured to establish a cross-section analysis model based on the cross-section design parameters, where the cross-section analysis model includes a concrete damage stress-strain relationship model and a reinforcement damage stress-strain relationship model; and
a calculation module configured to input the optical fiber strain signal to the cross-section analysis model to obtain a damage indicator and a bending moment-curvature curve of each cross-section.

Optionally, the calculation module includes:
a neutral axis assumption unit configured to set a position of a neutral axis of an xth cross-section at a time t as y_{0,x}(t);
a curvature calculation unit configured to calculate, based on the cross-section design parameters, the optical fiber strain signal, and the position of the neutral axis, a curvature of the xth cross-section at the time t by a formula ϕₓ(t)=ε_{s,x}(t)/(y_{0,x}(t)−d), where ϕₓ(t) represents the curvature of the xth cross-section at the time t; ε_{s,x}(t) represents the optical fiber strain signal; and d represents the equivalent cross-section height;
a strain calculation unit configured to calculate, based on the curvature, a strain distribution of concrete fibers of the xth cross-section at the time t and a strain distribution of compressive reinforcement fibers of the xth cross-section at the time t;
a concrete stress calculation unit configured to calculate, based on the strain distribution of the concrete fibers of the xth cross-section at the time t, a stress distribution and a damage indicator of the concrete fibers of the xth cross-section at the time t using the concrete damage stress-strain relationship model;
a reinforcement stress calculation unit configured to calculate, based on the strain distribution of reinforcement fibers of the xth cross-section at the time t, a stress distribution and a damage indicator of the reinforcement fibers of the xth cross-section at the time t using the reinforcement damage stress-strain relationship model, where the strain distribution of the reinforcement fibers of the xth cross-section at the time t includes a strain distribution of tensile reinforcement fibers of the xth cross-section at the time t and the strain distribution of the compressive reinforcement fibers of the xth cross-section at the time t;
a resultant force calculation unit configured to calculate a resultant force of axial forces based on the stress distribution and the damage indicator of the concrete fibers of the xth cross-section at the time t and the stress distribution and the damage indicator of the reinforcement fibers of the xth cross-section at the time t;
a determination unit configured to determine whether the resultant force of the axial forces is zero;
a first execution unit configured to, if the resultant force of the axial forces is zero, calculate and output the damage indicator and the bending moment-curvature curve of the xth cross-section at the time t; and
a second execution unit configured to, if the resultant force of the axial forces is not zero, return to “setting a position of a neutral axis of the xth cross-section at a time t as y_{0,x}(t)”.

Optionally, the resultant force calculation unit includes:
a resultant force calculation subunit configured to calculate the resultant force of the axial forces by the following formula:

$$\sum Nx ( t ) = {\sum }_{i = 1}^{n ( x )} ( 1 - {D}_{ci , x} ( {ε}_{ci , x} ( t ) ) ) {σ}_{ci , x} ( {ε}_{ci , x} ( t ) ) {A}_{c , i} + ( 1 - {D}_{s , x} ( {ε}_{s , x} ( t ) ) ) {σ}_{s , x} ( {ε}_{s , x} ( t ) ) {A}_{s} + ( 1 - {D}_{s , x} ( {ε}_{sc , x} ( t ) ) ) {σ}_{s , x} ( {ε}_{sc , x} ( t ) ) {A}_{s}^{′}$$

where ΣNx( ) represents the resultant force of the axial forces; D_{ci,x}(ε_{ci,x}(t)) represents a damage indicator of the ith concrete fiber of the xth cross-section at the time t, and D_{s,x}(ε_{sc,x}(t)) represents a damage indicator of the compressive reinforcement fibers of the xth cross-section at the time t; D_{s,x}(ε_{s,x}(t)) represents a damage fiber of the tensile reinforcement fibers of the xth cross-section at the time t; A_{c,i}=(bh/n(x)) represents an area of the ith concrete fiber; b represents the cross-section width; h represents the cross-section height; Aₛ represents an area of the tensile reinforcement fibers; Aₛ′ represents an area of the compressive reinforcement fibers; σ_{s,x}(ε_{sc,x}(t)) represents a stress distribution of the compressive reinforcement fibers of the xth cross-section at the time t; σ_{s,x}(ε_{s,x}(t)) represents the strain distribution of the tensile reinforcement fibers of the xth cross-section at the time t; σ_{ci,x}(ε_{ci,x}(t)) represents a stress of the ith concrete fiber in the xth cross-section at the time t; and n(x) represents a number of the concrete fibers in the xth cross-section.

Optionally, the first execution unit includes:
a damage indicator calculation subunit configured to calculate the damage indicator of the xth cross-section at the time t by a formula

$${D}_{sec , x} ( t ) = 1 - \frac{A - {B}^{2} / C}{{A}^{′} - {B}^{′2} / {C}^{′}} ,$$

$$A = {\sum }_{i = 1}^{n ( x )} ( 1 - {D}_{ci , x} ( {ε}_{ci , x} ( t ) ) ) {E}_{0} {A}_{c , i} {{y}_{i , x} ( t )}^{2} + ( 1 - {D}_{s , x} ( {ε}_{s , x} ( t ) ) ) {E}_{s} \text{?} {( d - h + {y}_{0 , x} ( t ) )}^{2} + ( 1 - \text{?} ( \text{?} ( t ) ) ) {E}_{s} \text{?} {( h - \text{?} - {y}_{0 , x} ( t ) )}^{2} ,$$

$$\text{?} = {E}_{0} {A}_{c , i} \text{?} {( t )}^{2} + {E}_{s} {{A}_{s} ( d - h + {y}_{0 , x} ( t ) )}^{2} + {E}_{s} \text{?} {( h - \text{?} - {y}_{0 , x} ( t ) )}^{2} ,$$

$$where$$

$$B = {\sum }_{i = 1}^{n ( x )} ( 1 - {D}_{ci , x} ( {ε}_{ci , x} ( t ) ) ) {E}_{0} {A}_{c , i} {y}_{i , x} ( t ) + ( 1 - {D}_{s , x} ( {ε}_{s , x} ( t ) ) ) \text{} {E}_{s} {A}_{s} ( d - h + {y}_{0 , x} ( t ) ) + ( 1 - \text{?} ( {ε}_{sc , x} ( t ) ) ) {E}_{s} \text{?} ( h - \text{?} - {y}_{0 , x} ( t ) ) ,$$

$$\text{?} = {E}_{0} {A}_{c , i} \text{?} ( t ) + {E}_{s} {A}_{s} ( d - h + {y}_{0 , x} ( t ) ) + {E}_{s} \text{?} ( h - \text{?} - {y}_{0 , x} ( t ) ) ,$$

$$C = {\sum }_{i = 1}^{n ( x )} ( 1 - {D}_{ci , x} ( {ε}_{ci , x} ( t ) ) ) {E}_{0} \text{?} + ( 1 - \text{?} ( {ε}_{s , x} ( t ) ) ) \text{?} + ( 1 - {D}_{s , x} ( {ε}_{sc , x} ( t ) ) ) \text{?} ,$$

$$\text{?} = {\sum }_{i = 1}^{n ( x )} {E}_{0} {A}_{c , i} + {E}_{s} {A}_{s} + {E}_{s} \text{?} ;$$

$$\text{?} \text{indicates text missing or illegible when filed}$$

D_{ci,x}(ε_{ci,x}(t)) represents the damage indicator of the ith concrete fiber of the xth cross-section at the time t; D_{s,x}(ε_{sc,x}(t)) represents the damage indicator of the compressive reinforcement fibers of the xth cross-section at the time t; D_{s,x}(ε_{s,x}(t)) represents the damage indicator of the tensile reinforcement fibers of the xth cross-section at the time t; h represents the cross-section height; Aₛ represents the area of the tensile reinforcement fibers; Aₛ′ represents the area of the compressive reinforcement fibers; σ_{s,x}(ε_{sc,x}(t)) represents the stress distribution of the compressive reinforcement fibers of the xth cross-section at the time t; σ_{s,x}(ε_{s,x}(t)) represents the strain distribution of the tensile reinforcement fibers of the xth cross-section at the time t; σ_{ci,x}(ε_{ci,x}(t)) represents the stress of the ith concrete fiber in the xth cross-section at the time t; E₀ represents the initial tangent modulus of concrete; d′ represents the protective layer thickness; Eₛ represents the initial tangent modulus of the reinforcement; A_{c,i} represents the area of the ith concrete fiber; n(x) represents the number of the concrete fibers in the xth cross-section;
a bending moment calculation subunit configured to calculate a bending moment Mx(t)=Mcx(t)+Msx(t) of the xth cross-section based on a sum of products of axial forces of the concrete fibers and distances of centers of the concrete fibers from the neutral axis y_{0,x}(t) and a sum of products of axial forces of the reinforcement fibers and distances of centers of the reinforcement fibers from the neutral axis y_{0,x}(t), where Mcx(t) represents a bending moment of the concrete fibers of the xth cross-section at the time t,

$$Msx ( t ) = \text{?} ( 1 - {D}_{ci , x} ( {ε}_{ci , x} ( t ) ) ) {σ}_{ci , x} ( {ε}_{ci , x} ( t ) ) {A}_{c , i} {y}_{i , x} ( t ) ,$$

$$\text{?} \text{indicates text missing or illegible when filed}$$

y_{i,x}(t) represents a distance of a center of the ith concrete fiber in the xth cross-section at the time t from the neutral axis; and Msx(t) represents a bending moment of the xth cross-section at the time t,

$$Msx ( t ) = ( 1 - \text{?} ( {ε}_{s , x} ( t ) ) ) {σ}_{s , x} ( {ε}_{s , x} ( t ) ) \text{?} ( d - h + {y}_{0 , x} ( t ) ) + ( 1 - {D}_{s , x} ( {ε}_{sc , x} ( t ) ) ) {σ}_{s , x} ( {ε}_{sc , x} ( t ) ) \text{?} ( h - \text{?} - {y}_{0 , x} ( t ) ) \text{?} and$$

$$\text{?} \text{indicates text missing or illegible when filed}$$

a curve plotting subunit configured to plot the bending moment-curvature curve based on the bending moment and the curvature.

According to specific embodiments provided in the present disclosure, the present disclosure has the following technical effects:

The distributed optical fiber sensor is disposed on the tensile reinforcement of the reinforced concrete beam in the present disclosure, and the optical fiber strain signal acquired by the distributed optical fiber sensor is input to the established cross-section analysis model to calculate the damage indicator and the damage mechanical properties of each cross-section. The present disclosure combines the distributed optical fiber sensing technology with the damage assessment theory for cross-section analysis, realizes inversion of the locally monitored strain into the damage indicator and the damage mechanical properties corresponding to each cross-section, and realizes quantitative monitoring on a damaged cross-section.

### BRIEF DESCRIPTION OF THE DRAWINGS

FIG. 1 is a flowchart of a method for quantitative damage monitoring of a reinforced concrete structure provided in the present disclosure;

FIG. 2 is a schematic diagram of partitioning of cross-section units provided in the present disclosure;

FIG. 3 is a schematic diagram of partitioning of concrete fibers provided in the present disclosure;

FIG. 4 is a flowchart of calculating a damage indicator and a bending moment-curvature curve of a cross-section using a cross-section analysis model in practical use; and

FIG. 5 is a structural diagram of a system for quantitative damage monitoring of a reinforced concrete structure provided in the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments derived from the embodiments in the present disclosure by a person of ordinary skill in the art without creative efforts shall fall within the protection scope of the present disclosure.

An objective of the present disclosure is to provide a method and system for quantitative damage monitoring of a reinforced concrete structure to solve the problem that a structural damage analysis method in the prior art cannot realize quantitative monitoring and assessment on the damage of a structure.

In view of the shortcomings of an existing structure damage monitoring technique, the problem to be mainly solved in the present disclosure is to quantitatively monitor the properties of a damaged cross-section to assess the damage degree (a reinforcement damage indicator, a concrete damage indicator, and a cross-section damage indicator) of the cross-section and mechanical properties (load and deflection). Therefore, there is provided a method for quantitative damage monitoring of a reinforced concrete structure, where a distributed optical fiber sensor is disposed on a tensile reinforcement of a reinforced concrete beam, and strain data acquired by the distributed optical fiber sensor is input to a cross-section analysis program to calculate a damage indicator and damage mechanical properties of each cross-section.

The present disclosure allows for quantitative monitoring on a damage state of a cross-section of interest based on a strain signal of a longitudinal tensile reinforcement acquired by distributed optical fibers and a cross-section analysis program written by Matlab. A damage factor and mechanical properties corresponding to each damaged cross-section may be inverted from a monitored local strain signal, and quantitative analysis can be performed on the degradation of the overall performance of a structure to assess the attenuation of the overall performance of the structure and the residual performance. A solution is provided for quantitative damage monitoring and assessment of a newly built reinforced concrete structure.

In order to make the above objective, features and advantages of the present disclosure clearer and more comprehensible, the present disclosure will be further described in detail below in combination with accompanying drawings and particular implementation modes.

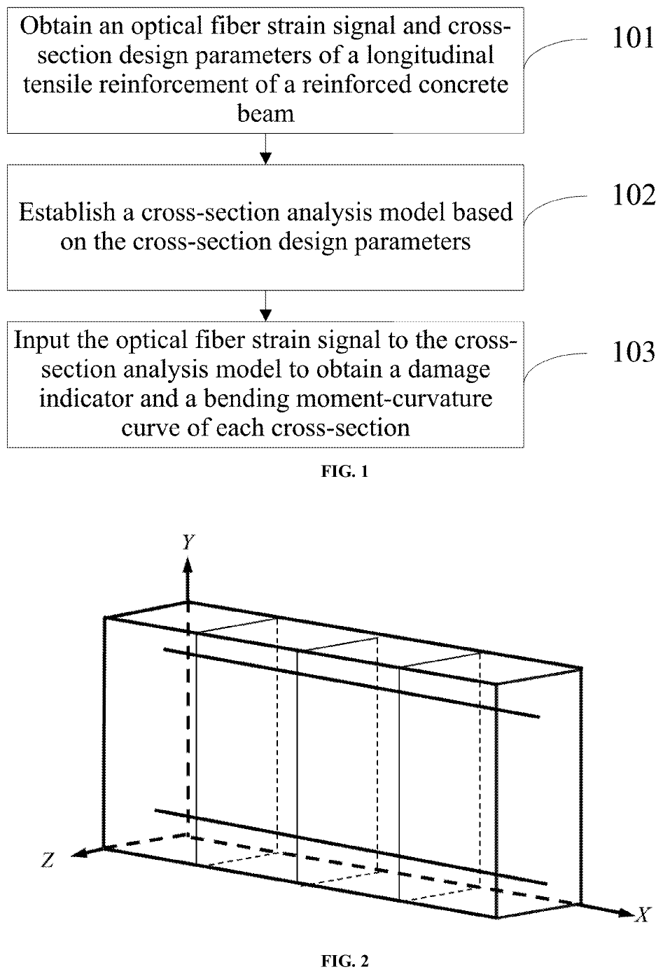

FIG. 1 is a flowchart of a method for quantitative damage monitoring of a reinforced concrete structure provided in the present disclosure, as shown in FIG. 1, including the following steps.

Step 101: an optical fiber strain signal and cross-section design parameters of a longitudinal tensile reinforcement of a reinforced concrete beam are obtained. The cross-section design parameters include geometric parameters and material performance parameters; the geometric parameters include a cross-section width, a cross-section height, an equivalent cross-section height, a protective layer thickness, and a reinforcement area; and the material performance parameters include a compression peak stress of concrete, an initial tangent modulus of concrete, and an initial tangent modulus of a reinforcement.

In practical use, distributed optical fibers are arranged in the longitudinal tensile reinforcement of the newly built reinforced concrete beam in advance, and the optical fiber strain signal is acquired in real time.

Step 102: a cross-section analysis model is established based on the cross-section design parameters. The cross-section analysis model includes a concrete damage stress-strain relationship model and a reinforcement damage stress-strain relationship model.

In practical use, a damaged cross-section analysis program is established: the cross-section analysis program is written in Matlab based on the cross-section design parameters (the geometric parameters and the material performance parameters), i.e., the cross-section analysis model is established. A material model (stress-strain relationship) in the analysis program uses a concrete damage stress-strain relationship and a reinforcement damage stress-strain relationship.

The cross-section analysis program is an important component of the present disclosure, which is specifically as follows.

Assumptions adopted in the calculation of the cross-section analysis program are as follows:
(1) An ultimate state of a cross-section is defined as the outermost concrete fibers of a compressive zone reaching an ultimate compressive strain.
(2) A stress state of the cross-section accords with a plane assumption.
(3) The fibers in the cross-section being tensioned is negative and the fibers in the cross-section being compressed is positive.

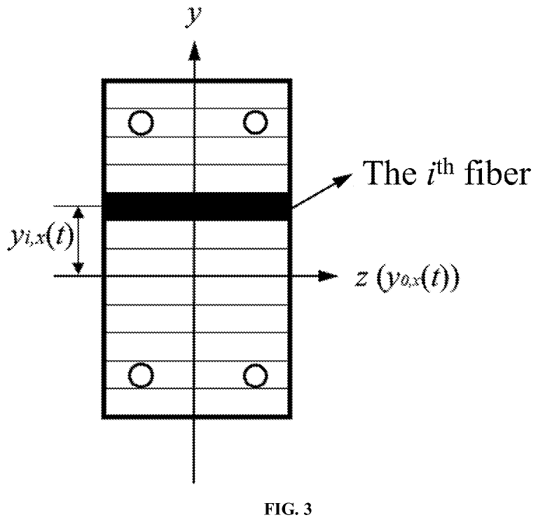

In a specific implementation, the reinforced concrete beam is divided into m cross-section units along X axis in a length direction, as shown in FIG. 2, and the cross-section units are as many as distributed optical fiber strain measuring points. Each cross-section is equally divided into n fibers along y axis in a height direction, as shown in FIG. 3.

Step 103: the optical fiber strain signal is input to the cross-section analysis model to obtain a damage indicator and a bending moment-curvature curve of each cross-section.

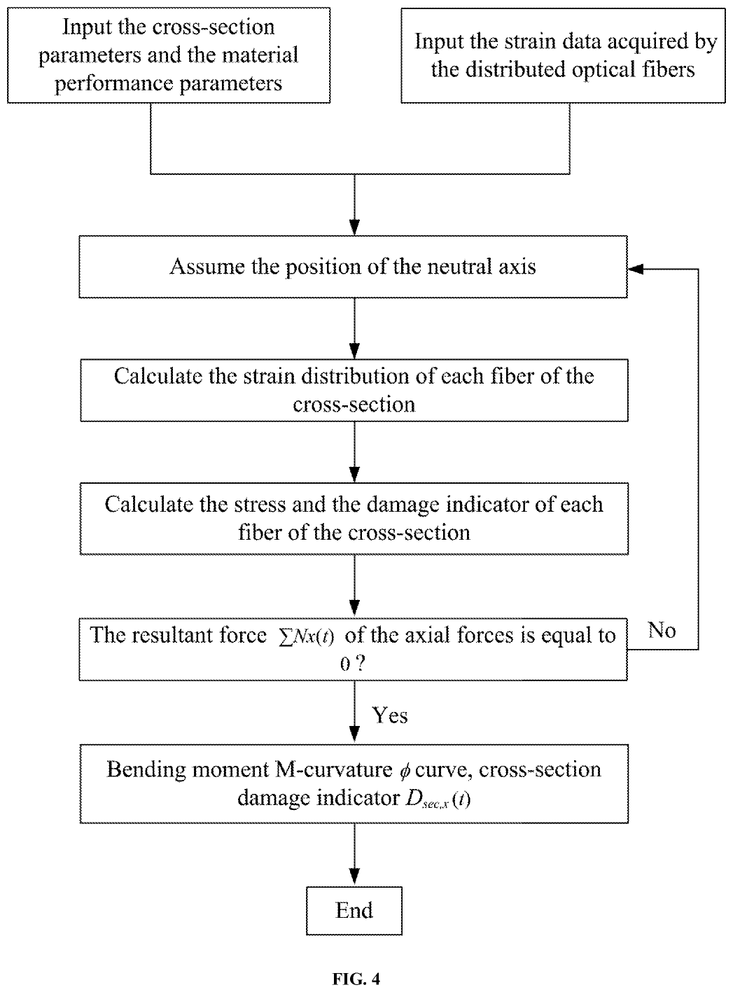

A flow of calculating a damage indicator and a bending moment-curvature curve of a cross-section using a cross-section analysis program is as shown in FIG. 4, and detailed steps are as follows.

S1: the cross-section design parameters (e.g., the geometric parameters (such as the cross-section width b, the cross-section height h, the equivalent cross-section height, the protective layer thickness, and the reinforcement area) and the material performance parameters (such as the compression peak stress of concrete, the initial tangent modulus of concrete, and the initial tangent modulus of the reinforcement)) and a strain distribution (denoted as ε_{s,x}(t), i.e., the optical fiber strain signal) of tensile reinforcement fibers of the xth cross-section acquired by the distributed optical fibers at a time t are input to the cross-section analysis model. The subscript x is used to denote a serial number of a cross-section in the present disclosure.

S2: it is assumed that a position of a neutral axis of the xth cross-section at a time t is y_{0,x}(t).

S3: a curvature of the xth cross-section at the time t is calculated based on the cross-section design parameters, the optical fiber strain signal, and the position of the neutral axis by a formula ϕₓ(t)=ε_{s,x}(t)/(y_{0,x}(t)−d), where ϕₓ(t) represents the curvature of the xth cross-section at the time t; ε_{s,x}(t) represents the optical fiber strain signal; and d represents the equivalent cross-section height.

S4: a strain distribution of concrete fibers of the xth cross-section at the time t and a strain distribution of compressive reinforcement fibers of the xth cross-section at the time t are calculated based on the curvature.

In practical use, the strain distributions of the concrete and reinforcement fibers of the xth cross-section at the time t are calculated, and the strain of the ith concrete fiber in the xth cross-section at the time t may be expressed as: ε_{ci,x}(t)=ϕₓ(t)y_{i,x}(t), where y_{i,x}(t) represents a distance of a center of the ith concrete fiber in the xth cross-section at the time t from the neutral axis; and the strain of the compressive reinforcement fibers in the xth cross-section at the time t may be expressed as: ε_{sc,x}(t)=ϕₓ(t))h−y_{0,x}(t)−d′), d′ representing the protective layer thickness, namely a distance of the center of the compressive reinforcement from the outermost compressive concrete fiber.

S5: a stress distribution and a damage indicator of the concrete fibers of the xth cross-section at the time t are calculated based on the strain distribution of the concrete fibers of the xth cross-section at the time t using the concrete damage stress-strain relationship model.

S6: a stress distribution and a damage indicator of reinforcement fibers of the xth cross-section at the time t are calculated based on the strain distribution of the reinforcement fibers of the xth cross-section at the time t using the reinforcement damage stress-strain relationship model, where the strain distribution of the reinforcement fibers of the xth cross-section at the time t includes a strain distribution of tensile reinforcement fibers of the xth cross-section at the time t and the strain distribution of the compressive reinforcement fibers of the xth cross-section at the time t.

The strains of the concrete and reinforcement fibers in the xth cross-section at the time t are substituted into the concrete damage stress-strain relationship model and the reinforcement damage stress-strain relationship model to calculate the stress distributions and the damage indicators of the concrete and reinforcement fibers of the cross-section at the corresponding time.

The stress of the ith concrete fiber in the xth cross-section at the time t may be expressed as σ_{ci,x}(ε_{ci,x}(t)); the stresses of the tensile and compressive reinforcement fibers of the xth cross-section at the time t may be expressed as σ_{s,x}(ε_{s,x}(t)) and σ_{s,x}(ε_{sc,x}(t)); the damage indicator of the ith concrete fiber in the xth cross-section at the time t may be expressed as D_{ci,x}(e_{ci,x}(t)); and the damage indicators of the tensile and compressive reinforcement fibers of the xth cross-section at the time t may be expressed as D_{s,x}(ε_{s,x}(t)) and D_{s,x}(ε_{sc,x}(t)).

The concrete damage stress-strain relationship in the cross-section analysis program is a concrete uniaxial damage stress-strain relationship given in the “Code for design of concrete structures” (GB 50010-2010), and the stress of the ith concrete fiber in the xth cross section at the time t is calculated.

Herein, σ_{ci,x}(ε_{ci,x}(t))=(1−D_{ci,x}(ε_{ci,x}(t)))E₀ε_{ci,x}(t), E₀ representing the initial tangent modulus of concrete.

When ε_{ci,x}(t)>0, the concrete fibers are compressed:

$${D}_{ci , x} ( {ε}_{ci , x} ( t ) ) = \{ \begin{matrix}1 - \frac{{f}_{c} / ( {E}_{0} {ε}_{0} - {f}_{c} )}{{f}_{c} / ( {E}_{0} {ε}_{0} - {f}_{c} ) + {( {ε}_{ci , x} ( t ) / {ε}_{0} )}^{{E}_{0} {ε}_{0} / ( {E}_{0} {ε}_{0} - {f}_{c} )}} & ( {ε}_{ci , x} ( t ) / {ε}_{0} ) \leq 1 \\ 1 - \frac{{f}_{c} / {E}_{0} {ε}_{0}}{{{α}_{c} ( ( {ε}_{ci , x} ( t ) / {ε}_{0} ) - 1 )}^{2} + ( {ε}_{ci , x} ( t ) / {ε}_{0} )} & ( {ε}_{ci , x} ( t ) / {ε}_{0} ) > 1\end{matrix} ,$$

where f_{c} represents a peak stress of unconfined concrete; ε₀ represents a peak strain corresponding to the peak stress of unconfined concrete; and a_{c} represents a parameter value of a descending segment of a uniaxial compression stress-strain curve.

When ε_{ci,x}(t)<0, the concrete fibers are tensioned:

$${D}_{ci , x} ( {ε}_{ci , x} ( t ) ) = \{ \begin{matrix}1 - \frac{{f}_{t}^{*} ( 1.2 ( {ε}_{ci , x} ( t ) / {ε}_{t} ) - 0.2 {( {ε}_{ci , x} ( t ) / {ε}_{t} )}^{6} )}{( {E}_{0} {ε}_{ci , x} ( t ) )} ( {ε}_{ci , x} ( t ) / {ε}_{t} ) \leq 1 \\ 1 - \frac{\begin{matrix}{f}_{t}^{*} ( {ε}_{ci , x} ( t ) / {ε}_{t} ) / ( {{α}_{t} ( ( {ε}_{ci , x} ( t ) / {ε}_{t} ) - 1 )}^{1.7} + \\ ( {ε}_{ci , x} ( t ) / {ε}_{t} ) )\end{matrix}}{( {E}_{0} {ε}_{ci , x} ( t ) )} ( {ε}_{ci , x} ( t ) / {ε}_{t} ) > 1\end{matrix} ,$$

where aₜ represents a parameter value of a descending segment of a uniaxial tension stress-strain curve; f*ₜ represents a uniaxial tensile strength of concrete; and εₜ represents a peak tensile strain of concrete corresponding f*ₜ.

The stress of the tensile reinforcement fibers of the xth cross-section at the time t is expressed as σ_{s,x}(ε_{s,x}(t))=(1−D_{s,x}(ε_{s,x}(t)))Eₛε_{s,x}(t); and the damage indicator is expressed as

$${D}_{s , x} ( {ε}_{s , x} ( t ) ) = \{ \begin{matrix}0 {ε}_{s , x} ( t ) / {ε}_{y} \leq 1 \\ 1 - ( {ε}_{y} + 0.01 ( {ε}_{s , x} ( t ) - {ε}_{y} ) ) / {ε}_{s , x} ( t ) {ε}_{s , x} ( t ) / {ε}_{y} > 1\end{matrix} .$$

The stress of the compressive reinforcement fibers of the xth cross-section at the time t is expressed as σ_{s,x}(ε_{sc,x}(t))=(1−D_{s,x}(ε_{sc,x}(t)))Eₛε_{sc,x}(t); and the damage indicator is expressed as

$${D}_{s , x} ( {ε}_{sc , x} ( t ) ) = \{ \begin{matrix}0 {ε}_{sc , x} ( t ) / {ε}_{y} \leq 1 \\ 1 - ( {ε}_{y} + 0.01 ( {ε}_{sc , x} ( t ) - {ε}_{y} ) ) / {ε}_{sc , x} ( t ) {ε}_{sc , x} ( t ) / {ε}_{y} > 1\end{matrix} .$$

Herein, Eₛ represents the initial tangent modulus of the reinforcement, and cy represents a yield strain of the reinforcement.

S7: a resultant force of axial forces is calculated based on the stress distribution and the damage indicator of the concrete fibers of the xth cross-section at the time t and the stress distribution and the damage indicator of the reinforcement fibers of the xth cross-section at the time t.

Further, the resultant force of the axial forces is calculated by the following formula:

$$\sum Nx ( t ) = {\sum }_{i = 1}^{n ( x )} ( 1 - {D}_{ci , x} ( {ε}_{ci , x} ( t ) ) ) {σ}_{ci , x} ( {ε}_{ci , x} ( t ) ) {A}_{c , i} + ( 1 - {D}_{s , x} ( {ε}_{s , x} ( t ) ) ) {σ}_{s , x} ( {ε}_{s , x} ( t ) ) {A}_{s} + ( 1 - {D}_{s , x} ( {ε}_{sc , x} ( t ) ) ) {σ}_{s , x} ( {ε}_{sc , x} ( t ) ) {A}_{s}^{′} ,$$

where ΣNx(t) represents the resultant force of the axial forces; A_{c,i}=(bh/n(x)) represents an area of the ith concrete fiber; b represents the cross-section width; h represents the cross-section height; Aₛ represents an area of the tensile reinforcement fibers; Aₛ′ represents an area of the compressive reinforcement fibers; and n(x) represents a number of the concrete fibers in the xth cross-section.

S8: whether the resultant force of the axial forces is zero is determined.

S9: if the resultant force of the axial forces is zero, the damage indicator and the bending moment-curvature curve of the xth cross-section at the time t are calculated and output.

S10: if the resultant force of the axial forces is not zero, the step “setting a position of a neutral axis of the xth cross-section at a time t as y_{0,x}(t)” is performed,

Whether the resultant force ΣNx(t) of the axial forces in the xth cross-section at the time t is 0 is determined. If the resultant force ΣNx(t) of the axial forces in the xth cross-section at the time t is 0, it represents the neutral axis assumed in step S2 is a real neutral axis, and next step may be performed. If the resultant force ΣNx(t) of the axial forces in the xth cross-section at the time (is 0, the height of the neutral axis needs to be assumed again, and the calculations of S2-S7 are repeated.

Specifically, the damage indicator of the xth cross-section at the time t is calculated by a formula

$${D}_{sec , x} ( t ) = 1 - \frac{A - {B}^{2} / C}{{A}^{′} - {B}^{′2} / {C}^{′}} ,$$

where

$$A = {\sum }_{i = 1}^{n ( x )} ( 1 - {D}_{ci , x} ( {ε}_{ci , x} ( t ) ) ) {E}_{0} {A}_{c , i} {{y}_{i , x} ( t )}^{2} + ( 1 - {D}_{s , x} ( {ε}_{s , x} ( t ) ) ) \text{?} {( d - h + {y}_{0 , x} ( t ) )}^{2} + ( 1 - \text{?} ( \text{?} ( t ) ) ) {E}_{s} \text{?} {( h - \text{?} - {y}_{0 , x} ( t ) )}^{2} ,$$

$$\text{?} = {E}_{0} {A}_{c , i} \text{?} {( t )}^{2} + {E}_{s} {{A}_{s} ( d - h + {y}_{0 , x} ( t ) )}^{2} + {E}_{s} \text{?} {( h - \text{?} - {y}_{0 , x} ( t ) )}^{2} ,$$

$$B = {\sum }_{i = 1}^{n ( x )} ( 1 - {D}_{ci , x} ( {ε}_{ci , x} ( t ) ) ) {E}_{0} {A}_{c , i} {y}_{i , x} ( t ) + ( 1 - {D}_{s , x} ( {ε}_{s , x} ( t ) ) ) \text{} {E}_{s} {A}_{s} ( d - h + {y}_{0 , x} ( t ) ) + ( 1 - \text{?} ( {ε}_{sc , x} ( t ) ) ) {E}_{s} \text{?} ( h - \text{?} - {y}_{0 , x} ( t ) ) ,$$

$$\text{?} = {E}_{0} {A}_{c , i} \text{?} ( t ) + {E}_{s} {A}_{s} ( d - h + {y}_{0 , x} ( t ) ) + {E}_{s} \text{?} ( h - \text{?} - {y}_{0 , x} ( t ) ) ,$$

$$C = {\sum }_{i = 1}^{n ( x )} ( 1 - {D}_{ci , x} ( {ε}_{ci , x} ( t ) ) ) {E}_{0} \text{?} + ( 1 - \text{?} ( {ε}_{s , x} ( t ) ) ) \text{?} + ( 1 - {D}_{s , x} ( {ε}_{sc , x} ( t ) ) ) \text{?} ,$$

$$\text{?} = {\sum }_{i = 1}^{n ( x )} {E}_{0} {A}_{c , i} + {E}_{s} {A}_{s} + {E}_{s} \text{?} ;$$

$$\text{?} \text{indicates text missing or illegible when filed}$$

D_{ci,x}(ε_{ci,x}(t)) represents the damage indicator of the ith concrete fiber of the xth cross-section at the time t; D_{s,x}(ε_{sc,x}(t)) represents the damage indicator of the compressive reinforcement fibers of the xth cross-section at the time t; D_{s,x}(ε_{s,x}(t)) represents the damage indicator of the tensile reinforcement fibers of the xth cross-section at the time t; E₀ represents the initial tangent modulus of concrete; d′ represents the protective layer thickness; Eₛ represents the initial tangent modulus of the reinforcement; A_{c,i} represents the area of the ith concrete fiber; and n(x) represents the number of the concrete fibers in the xth cross-section. In addition, A, B, C, A′, B′, and C′ are intermediate variables in simplified calculations and have no specific meaning.

A bending moment Mx(t)=Mcx(t)±Msx(t) of the xth cross-section is calculated based on a sum of products of axial forces of the concrete fibers and distances of centers of the concrete fibers from the neutral axis y_{0,x}(t) and a sum of products of axial forces of the reinforcement fibers and distances of centers of the reinforcement fibers from the neutral axis y_{0,x}(t), where Mcx(t) represents a bending moment of the concrete fibers of the xth cross-section at the time t,

$$Mcx ( t ) = {\sum }_{i = 1}^{n ( x )} ( 1 - {D}_{ci , x} ( {ε}_{ci , x} ( t ) ) ) {σ}_{ci , x} ( {ε}_{ci , x} ( t ) ) {A}_{c , i} {y}_{i , x} ( t ) ;$$

and Msx(t) represents the bending moment of the reinforcement fibers of the xth cross-section at the time t,

$$Msx ( t ) = ( 1 - {D}_{s , x} ( {ε}_{s , x} ( t ) ) ) {σ}_{s , x} ( {ε}_{s , x} ( t ) ) {A}_{s} ( d - h + {y}_{0 , x} ( t ) ) + ( 1 - {D}_{s , x} ( {ε}_{sc , x} ( t ) ) ) {σ}_{s , x} ( {ε}_{sc , x} ( t ) ) {A}_{s}^{′} ( h - {d}^{′} - {y}_{0 , x} ( t ) ) ;$$

The bending moment-curvature curve is plotted based on the bending moment and the curvature.

S1-S10 may be repeated to calculate the bending moment-curvature curves and the damage indicators of all the cross-sections (m cross-sections).

The present disclosure allows for inversion of the damage factor and the mechanical properties of the cross-section of interest from the acquired strain signal by combining the distributed optical fiber sensing technology with the damaged cross-section analysis method. The stresses, strains, and damage variables of the concrete fibers and the reinforcement fibers within the cross-section can be shown, and the mechanical properties and the damage indicator of the cross-section can be quantitatively assessed.

The present disclosure involves simple arrangement of a sensor. The stress state and the damage indicator of each cross-section can be quantitatively obtained with the distributed optical fiber sensor that only needs to be arranged on the longitudinal tensile reinforcement.

By using the method for quantitative damage monitoring of a structure based on the distributed optical fiber strain provided in the present disclosure, the damage indicator and the mechanical properties of a key member of a reinforced concrete structure during service can be monitored in real time, and then the safety performance of the structure is assessed, providing guarantee and guidance for the maintenance and first-aid repair of the structure.

In the method for quantitative damage monitoring of a reinforced concrete structure in the present disclosure, the distributed optical fiber sensor in the method may be arranged in the longitudinal stressed member of a beam or column, such as a reinforcement, a fiber reinforced plastic (FRP) bar, a steel-FRP continuous fiber bar, and a steel plate. The premise of the method is obtaining the damage stress-strain relationship of a material, and replacement may be made according to a material type of a structure. The method is not limited to a cross-section shape of a structure. That is, the cross-section may be square or circular.

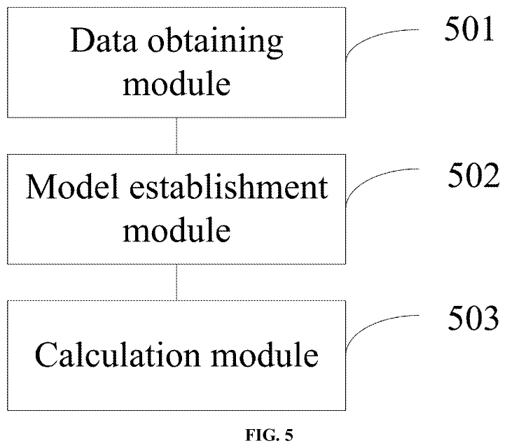

The present disclosure further provides a system for quantitative damage monitoring of a reinforced concrete structure, as shown in FIG. 5, including:
a data obtaining module 501 configured to obtain an optical fiber strain signal and cross-section design parameters of a longitudinal tensile reinforcement of a reinforced concrete beam, where the cross-section design parameters include geometric parameters and material performance parameters; the geometric parameters include a cross-section width, a cross-section height, an equivalent cross-section height, a protective layer thickness, and a reinforcement area; and the material performance parameters include a compression peak stress of concrete, an initial tangent modulus of concrete, and an initial tangent modulus of a reinforcement;
a model establishment module 502 configured to establish a cross-section analysis model based on the cross-section design parameters, where the cross-section analysis model includes a concrete damage stress-strain relationship model and a reinforcement damage stress-strain relationship model; and
a calculation module 503 configured to input the optical fiber strain signal to the cross-section analysis model to obtain a damage indicator and a bending moment-curvature curve of each cross-section.

Further, the calculation module 503 further includes:
a neutral axis assumption unit configured to set a position of a neutral axis of the xth cross-section at a time t as y_{0,x}(t);
a curvature calculation unit configured to calculate, based on the cross-section design parameters, the optical fiber strain signal, and the position of the neutral axis, a curvature of the xth cross-section at the time t by a formula ϕₓ(t)=ε_{s,x}(t)/(y_{0,x}(t)−d), where ϕₓ(t) represents the curvature of the xth cross-section at the time t; ε_{s,x}(t) represents the optical fiber strain signal; and d represents the equivalent cross-section height;
a strain calculation unit configured to calculate, based on the curvature, a strain distribution of concrete fibers of the xth cross-section at the time t and a strain distribution of compressive reinforcement fibers of the xth cross-section at the time t;
a concrete stress calculation unit configured to calculate, based on the strain distribution of the concrete fibers of the xth cross-section at the time t, a stress distribution and a damage indicator of the concrete fibers of the xth cross-section at the time t using the concrete damage stress-strain relationship model;
a reinforcement stress calculation unit configured to calculate, based on the strain distribution of reinforcement fibers of the xth cross-section at the time t, a stress distribution and a damage indicator of the reinforcement fibers of the xth cross-section at the time t using the reinforcement damage stress-strain relationship model, where the strain distribution of the reinforcement fibers of the xth cross-section at the time t includes a strain distribution of tensile reinforcement fibers of the xth cross-section at the time t and the strain distribution of the compressive reinforcement fibers of the xth cross-section at the time t;
a resultant force calculation unit configured to calculate a resultant force of axial forces based on the stress distribution and the damage indicator of the concrete fibers of the xth cross-section at the time t and the stress distribution and the damage indicator of the reinforcement fibers of the xth cross-section at the time t;
a determination unit configured to determine whether the resultant force of the axial forces is zero;
a first execution unit configured to, if the resultant force of the axial forces is zero, calculate and output the damage indicator and the bending moment-curvature curve of the xth cross-section at the time t; and
a second execution unit configured to, if the resultant force of the axial forces is not zero, return to “setting a position of a neutral axis of the xth cross-section at a time t as y_{0,x}(t)”.

Further, the resultant force calculation unit further includes:
a resultant force calculation subunit configured to calculate the resultant force of the axial forces by the following formula:

$$\sum Nx ( t ) = {\sum }_{i = 1}^{n ( x )} ( 1 - {D}_{ci , x} ( {ε}_{ci , x} ( t ) ) ) {σ}_{ci , x} ( {ε}_{ci , x} ( t ) ) {A}_{c , i} + ( 1 - {D}_{s , x} ( {ε}_{s , x} ( t ) ) ) {σ}_{s , x} ( {ε}_{s , x} ( t ) ) {A}_{s} + ( 1 - {D}_{s , x} ( {ε}_{sc , x} ( t ) ) ) {σ}_{s , x} ( {ε}_{sc , x} ( t ) ) {A}_{s}^{′} ,$$

where ΣNx(t) represents the resultant force of the axial forces; A_{c,i}=(bh/n(x)) represents an area of the ith concrete fiber; b represents the cross-section width; h represents the cross-section height; Aₛ represents an area of the tensile reinforcement fibers; Aₛ′ represents an area of the compressive reinforcement fibers; σ_{s,x}(ε_{sc,x}(t)) represents a stress distribution of the compressive reinforcement fibers of the xth cross-section at the time t; σ_{s,x}(ε_{s,x}(t)) represents the strain distribution of the tensile reinforcement fibers of the xth cross-section at the time t; σ_{ci,x}(ε_{ci,x}(t)) represents a stress of the ith concrete fiber in the xth cross-section at the time t; and n(x) represents a number of the concrete fibers in the xth cross-section.

Further, the first execution unit includes:
a damage indicator calculation subunit configured to calculate the damage indicator of the xth cross-section at the time t by a formula

$${D}_{sec , x} ( t ) = 1 - \frac{A - {B}^{2} / C}{{A}^{′} - {B}^{′2} / {C}^{′}} ,$$

where,

$$A = {\sum }_{i = 1}^{n ( x )} ( 1 - {D}_{ci , x} ( {ε}_{ci , x} ( t ) ) ) {E}_{0} {A}_{c , i} {{y}_{i , x} ( t )}^{2} + ( 1 - {D}_{s , x} ( {ε}_{s , x} ( t ) ) ) {E}_{s} {{A}_{s} ( d - h + {y}_{0 , x} ( t ) )}^{2} + ( 1 - {D}_{s , x} ( {ε}_{sc , x} ( t ) ) ) {E}_{s} {{A}_{s}^{′} ( h - {d}^{′} - {y}_{0 , x} ( t ) )}^{2} ,$$

$${A}^{′} = {E}_{0} {A}_{c , i} {{y}_{i , x} ( t )}^{2} + {E}_{s} {{A}_{s} ( d - h + {y}_{0 , x} ( t ) )}^{2} + {E}_{s} {{A}_{s}^{′} ( h - {d}^{′} - {y}_{0 , x} ( t ) )}^{2} ,$$

$$B = {\sum }_{i = 1}^{n ( x )} ( 1 - {D}_{ci , x} ( {ε}_{ci , x} ( t ) ) ) {E}_{0} {A}_{c , i} {y}_{i , x} ( t ) + ( 1 - {D}_{s , x} ( {ε}_{s , x} ( t ) ) ) {E}_{s} {A}_{s} ( d - h + {y}_{0 , x} ( t ) ) + ( 1 - {D}_{s , x} ( {ε}_{sc , x} ( t ) ) ) {E}_{s} {A}_{s}^{′} ( h - {d}^{′} - {y}_{0 , x} ( t ) ) ,$$

$${B}^{′} = {E}_{0} {A}_{c , i} {y}_{i , x} ( t ) + {E}_{s} {A}_{s} ( d - h + {y}_{0 , x} ( t ) ) + {E}_{s} {A}_{s}^{′} ( h - {d}^{′} - {y}_{0 , x} ( t ) ) ,$$

$$C = {\sum }_{i = 1}^{n ( x )} ( 1 - {D}_{ci , x} ( {ε}_{ci , x} ( t ) ) ) {E}_{0} {A}_{c , i} + ( 1 - {D}_{s , x} ( {ε}_{s , x} ( t ) ) ) {E}_{s} {A}_{s} + ( 1 - {D}_{s , x} ( {ε}_{sc , x} ( t ) ) ) {E}_{s} {A}_{s}^{′} ,$$

$${C}^{′} = {\sum }_{i = 1}^{n ( x )} {E}_{0} {A}_{c , i} + {E}_{s} {A}_{s} + {E}_{s} {A}_{s}^{′} ;$$

D_{ci,x}(ε_{ci,x}(t)) represents the damage indicator of the ith concrete fiber of the xth cross-section at the time t; D_{s,x}(ε_{sc,x}(t)) represents the damage indicator of the compressive reinforcement fibers of the xth cross-section at the time t; D_{s,x}(ε_{s,x}(t)) represents the damage indicator of the tensile reinforcement fibers of the xth cross-section at the time t; E₀ represents the initial tangent modulus of concrete; d′ represents the protective layer thickness; Eₛ represents the initial tangent modulus of the reinforcement; A_{c,i} represents the area of the ith concrete fiber; and n(x) represents the number of the concrete fibers in the xth cross-section.
a bending moment calculation subunit configured to calculate a bending moment Mx(t)=Mcx(t)+Msx(t) of the xth cross-section based on a sum of products of axial forces of the concrete fibers and distances of centers of the concrete fibers from the neutral axis y_{0,x}(t) and a sum of products of axial forces of the reinforcement fibers and distances of centers of the reinforcement fibers from the neutral axis y_{0,x}(t), where Mcx(t) represents a bending moment of the concrete fibers of the xth cross-section at the time t,

$$Mcx ( t ) = {\sum }_{i = 1}^{n ( x )} ( 1 - {D}_{ci , x} ( {ε}_{ci , x} ( t ) ) ) {σ}_{ci , x} ( {ε}_{ci , x} ( t ) ) {A}_{c , i} {y}_{i , x} ( t ) ;$$

and Msx(t) represents the bending moment of the reinforcement fibers of the xth cross-section at the time t,

$$Msx ( t ) = ( 1 - {D}_{s , x} ( {ε}_{s , x} ( t ) ) ) {σ}_{s , x} ( {ε}_{s , x} ( t ) ) {A}_{s} ( d - h + {y}_{0 , x} ( t ) ) + ( 1 - {D}_{s , x} ( {ε}_{sc , x} ( t ) ) ) {σ}_{s , x} ( {ε}_{sc , x} ( t ) ) {A}_{s}^{′} ( h - {d}^{′} - {y}_{0 , x} ( t ) ) ∘ ;$$

and
a curve plotting subunit configured to plot the bending moment-curvature curve based on the bending moment and the curvature.

The embodiments are described herein in a progressive manner. Each embodiment focuses on the difference from another embodiment, and the same and similar parts between the embodiments may refer to each other. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of application in accordance with the ideas of the present disclosure. In conclusion, the content of the description shall not be construed as limitations to the present disclosure.

1. A method for quantitative damage monitoring of a reinforced concrete structure, comprising:
obtaining an optical fiber strain signal and cross-section design parameters of a longitudinal tensile reinforcement of a reinforced concrete beam, wherein the cross-section design parameters comprise geometric parameters and material performance parameters; the geometric parameters comprise a cross-section width, a cross-section height, an equivalent cross-section height, a protective layer thickness, and a reinforcement area; and the material performance parameters comprise a compression peak stress of concrete, an initial tangent modulus of concrete, and an initial tangent modulus of a reinforcement;
establishing a cross-section analysis model based on the cross-section design parameters, wherein the cross-section analysis model comprises a concrete damage stress-strain relationship model and a reinforcement damage stress-strain relationship model; and
inputting the optical fiber strain signal to the cross-section analysis model to obtain a damage indicator and a bending moment-curvature curve of each cross-section;
monitoring damage indicators and mechanical properties of a key member of the reinforced concrete structure in real-time, so as to guarantee and guide a maintenance and a first-aid repair of the key member of the reinforced concrete structure according to the damage indicator and the bending moment-curvature curve of each cross-section;
wherein the inputting the optical fiber strain signal to the cross-section analysis model to obtain a damage indicator and a bending moment-curvature curve of each cross-section specifically comprises:
setting a position of a neutral axis of an xth cross-section at a time t as y_{0,x}(t);
calculating based on the cross-section design parameters, the optical fiber strain signal, and the position of the neutral axis, a curvature of the xth cross-section at the time t by a formula ϕₓ(t)=ε_{ci,x}(t)/(y_{0,x}(t)−d), wherein ϕₓ(t) represents the curvature of the xth cross-section at the time t; ε_{ci,x}(t) represents the optical fiber strain signal; and d represents the equivalent cross-section height;
calculating, based on the curvature, a strain distribution of concrete fibers of the xth cross-section at the time t and a strain distribution of compressive reinforcement fibers of the xth cross-section at the time t,
calculate, based on the strain distribution of the concrete fibers of the xth cross-section at the time t, a stress distribution and a damage indicator of the concrete fibers of the xth cross-section at the time t using the concrete damage stress-strain relationship model;
calculating, based on the strain distribution of reinforcement fibers of the xth cross-section at the time t, a stress distribution and a damage indicator of the reinforcement fibers of the xth cross-section at the time t using the reinforcement damage stress-strain relationship model, wherein the strain distribution of the reinforcement fibers of the xth cross-section at the time t comprises a strain distribution of tensile reinforcement fibers of the xth cross-section at the time t and the strain distribution of the compressive reinforcement fibers of the xth cross-section at the time t;
calculating a resultant force of axial forces based on the stress distribution and the damage indicator of the concrete fibers of the xth distribution at the time t and the stress distribution and the damage indicator of the reinforcement fibers of the xth distribution at the time t;
determining whether the resultant force of the axial forces is zero;
if the resultant force of the axial forces is zero, calculating and outputting the damage indicator and the bending moment-curvature curve of the xth cross-section at the time t, and
if the resultant force of the axial forces is not zero, returning to “setting a position of a neutral axis of the xth cross-section at a time t as y_{0,x}(t)”.

2. (canceled)

3. The method for quantitative damage monitoring of a reinforced concrete structure according to claim 2, wherein the calculating a resultant force of axial forces based on the stress distribution and the damage indicator of the concrete fibers of the xth cross-section at the time t and the stress distribution and the damage indicator of the reinforcement fibers of the xth cross-section at the time t specifically comprises:
calculating the resultant force of the axial forces by the following formula:
$$\sum Nx ( t ) = {\sum }_{i = 1}^{n ( x )} ( 1 - {D}_{ci , x} ( {ε}_{ci , x} ( t ) ) ) {σ}_{ci , x} ( {ε}_{ci , x} ( t ) ) {A}_{c , i} + ( 1 - {D}_{s , x} ( {ε}_{s , x} ( t ) ) ) {σ}_{s , x} ( {ε}_{s , x} ( t ) ) {A}_{s} + ( 1 - {D}_{s , x} ( {ε}_{sc , x} ( t ) ) ) {σ}_{s , x} ( {ε}_{sc , x} ( t ) ) {A}_{s}^{′}$$
wherein ΣNx(t) represents the resultant force of the axial forces; D_{ci,x}(ε_{ci,x}(t)) represents a damage indicator of an ith concrete fiber of the xth cross-section at the time t, and D_{s,x}(ε_{sc,x}(t)) represents a damage indicator of the compressive reinforcement fibers of the xth cross-section at the time t; D_{s,x}(ε_{s,x}(t)) represents a damage fiber of the tensile reinforcement fibers of the xth cross-section at the time t; A_{c,i}=(bh/n(x)) represents an area of the ith concrete fiber; b represents the cross-section width; h represents the cross-section height; Aₛ represents an area of the tensile reinforcement fibers; Aₛ′ represents an area of the compressive reinforcement fibers; σ_{s,x}(ε_{sc,x}(t)) represents a stress distribution of the compressive reinforcement fibers of the xth cross-section at the time t; σ_{s,x}(ε_{s,x}(t)) represents the strain distribution of the tensile reinforcement fibers of the xth cross-section at the time t; σ_{ci,x}(ε_{ci,x}(t)) represents a stress of the ith concrete fiber in the xth cross-section at the time t; and n(x) represents a number of the concrete fibers in the xth cross-section.

4. The method for quantitative damage monitoring of a reinforced concrete structure according to claim 2, wherein the calculating the damage indicator and the bending moment-curvature curve of the xth cross-section at the time t specifically comprises:
calculating the damage indicator of the xth cross-section at the time t by a formula
$${D}_{sec , x} ( t ) = 1 - \frac{A - {B}^{2} / C}{{A}^{′} - {B}^{′2} / {C}^{′}} ,$$
wherein,
$$A = {\sum }_{i = 1}^{n ( x )} ( 1 - {D}_{ci , x} ( {ε}_{ci , x} ( t ) ) ) {E}_{0} {A}_{c , i} {{y}_{i , x} ( t )}^{2} + ( 1 - {D}_{s , x} ( {ε}_{s , x} ( t ) ) ) {E}_{s} {A}_{s} ( d - {A}^{′} = {E}_{0} {A}_{c , i} {{y}_{i , x} ( t )}^{2} + {E}_{s} {{A}_{s} ( d - h + {y}_{0 , x} ( t ) )}^{2} + {E}_{s} {{A}_{s}^{′} ( h - {d}^{′} - {y}_{0 , x} ( t ) )}^{2} ,$$
$$B = {\sum }_{i = 1}^{n ( x )} ( 1 - {D}_{ci , x} ( {ε}_{ci , x} ( t ) ) ) {E}_{0} {A}_{c , i} {y}_{i , x} ( t ) + ( 1 - {D}_{s , x} ( {ε}_{s , x} ( t ) ) ) {E}_{s} {A}_{s} ( d - h + {y}_{0 , x} ( t ) ) + ( 1 - {D}_{s , x} ( {ε}_{sc , x} ( t ) ) ) {E}_{s} {A}_{s}^{′} ( h - {d}^{′} - {y}_{0 , x} ( t ) ) ,$$
$${B}^{′} = {E}_{0} {A}_{c , i} {y}_{i , x} ( t ) + {E}_{s} {A}_{s} ( d - h + {y}_{0 , x} ( t ) ) + {E}_{s} {A}_{s}^{′} ( h - {d}^{′} - {y}_{0 , x} ( t ) ) ,$$
$$C = {\sum }_{i = 1}^{n ( x )} ( 1 - {D}_{ci , x} ( {ε}_{ci , x} ( t ) ) ) {E}_{0} {A}_{c , i} + ( 1 - {D}_{s , x} ( {ε}_{s , x} ( t ) ) ) {E}_{s} {A}_{s} + ( 1 - {D}_{s , x} ( {ε}_{sc , x} ( t ) ) ) {E}_{s} {A}_{s}^{′} ,$$
$${C}^{′} = {\sum }_{i = 1}^{n ( x )} {E}_{0} {A}_{c , i} + {E}_{s} {A}_{s} + {E}_{s} {A}_{s}^{′} ;$$
D_{ci,x}(ε_{ci,x}(t)) represents the damage indicator of the ith concrete fiber of the xth cross-section at the time t; D_{s,x}(ε_{s,x}(t)) represents the damage indicator of the compressive reinforcement fibers of the xth cross-section at the time t; D_{s,x}(ε_{s,x}(t)) represents the damage indicator of the tensile reinforcement fibers of the xth cross-section at the time t; h represents the cross-section height; Aₛ represents the area of the tensile reinforcement fibers; Aₛ′ represents the area of the compressive reinforcement fibers; σ_{s,x}(ε_{sc,x}(t)) represents the stress distribution of the compressive reinforcement fibers of the xth cross-section at the time t; ∝_{s,x}(ε_{s,x}(t)) represents the strain distribution of the tensile reinforcement fibers of the xth cross-section at the time t; σ_{ci,x}(ε_{ci,x}(t)) represents the stress of the ith concrete fiber in the xth cross-section at the time t; E₀ represents the initial tangent modulus of concrete; d′ represents the protective layer thickness; Eₛ represents the initial tangent modulus of the reinforcement; A_{c,i} represents the area of the ith concrete fiber; n(x) represents the number of the concrete fibers in the xth cross-section;
calculating a bending moment Mx(t)=Mcx(t)+Msx(t) of the xth cross-section based on a sum of products of axial forces of the concrete fibers and distances of centers of the concrete fibers from the neutral axis y_{0,x}(t) and a sum of products of axial forces of the reinforcement fibers and distances of centers of the reinforcement fibers from the neutral axis y_{0,x}(t), wherein Mcx(t) represents a bending moment of the concrete fibers of the xth cross-section at the time t, Mcx(t)=y_{i,x}(t) represents a distance of a center of the ith concrete fiber in the xth cross-section at the time t from the neutral axis; and Msx(t) represents a bending moment of the xth cross-section at the time t,
$$Msx ( t ) = ( 1 - {D}_{s , x} ( {ε}_{s , x} ( t ) ) ) {σ}_{s , x} ( {ε}_{s , x} ( t ) ) {A}_{s} ( d - h + {y}_{0 , x} ( t ) ) + ( 1 - {D}_{s , x} ( {ε}_{sc , x} ( t ) ) ) {σ}_{s , x} ( {ε}_{sc , x} ( t ) ) {A}_{s}^{′} ( h - {d}^{′} - {y}_{0 , x} ( t ) ) ;$$
and
obtaining the bending moment-curvature curve based on the bending moment and the curvature.

5. A system for quantitative damage monitoring of a reinforced concrete structure, comprising:
a data obtaining module configured to obtain an optical fiber strain signal and cross-section design parameters of a longitudinal tensile reinforcement of a reinforced concrete beam, wherein the cross-section design parameters comprise geometric parameters and material performance parameters; the geometric parameters comprise a cross-section width, a cross-section height, an equivalent cross-section height, a protective layer thickness, and a reinforcement area; and the material performance parameters comprise a compression peak stress of concrete, an initial tangent modulus of concrete, and an initial tangent modulus of a reinforcement;
a model establishment module configured to establish a cross-section analysis model based on the cross-section design parameters, wherein the cross-section analysis model comprises a concrete damage stress-strain relationship model and a reinforcement damage stress-strain relationship model; and
a calculation module configured to input the optical fiber strain signal to the cross-section analysis model to obtain a damage indicator and a bending moment-curvature curve of each cross-section;
the system further configured to monitor damage indicators and mechanical properties of a key member of the reinforced concrete structure in real-time, so as to guarantee and guide a maintenance and a first-aid repair of the key member of the reinforced concrete structure according to the damage indicator and the bending moment-curvature curve of each cross-section;
wherein the calculation module comprises:
a neutral axis assumption unit configured to set a position of a neural axis of an xth cross-section at a time t as y_{0,x}(t);
a curvature calculation unit configured to calculate, based on the cross-section design parameters, the optical fiber strain signal, and the position of the neutral axis, a curvature of the xth cross-section at the time t by a formula ϕₓ(t)=ε_{s,x}(t)/(y_{0,x}(t)−d), wherein ϕₓ(t) represents the curvature of the xth cross-section at the time t; ε_{s,x}(t) represents the optical fiber strain signal, and d represents the equivalent cross-section height;
a strain calculation unit configured to calculate, based on the curvature, a strain distribution of concrete fibers of the xth cross-section at the time t and a strain distribution of compressive reinforcement fibers of the xth cross-section at the time t;
a concrete stress calculation unit configured to calculate, based on the strain distribution of the concrete fibers of the xth cross-section at the time t, a stress destruction and a damage indicator of the concrete fibers of the xth cross-section at the time t using the concrete damage stress-strain relationship model,
a reinforcement stress calculation unit configured to calculate, based on the strain distribution of reinforcement fibers of the xth cross-section at the time t, a stress distribution and a damage indicator of the reinforcement fibers of the xth cross-section at the time t using the reinforcement damage stress-strain relationship model, wherein the strain distribution of the reinforcement fibers of the xth cross-section at the time t comprises a strain distribution of tensile reinforcement fibers of the xth cross-section at the time t and the strain distribution of the compressive reinforcement fibers of the xth cross-section at the time t;
a resultant force calculation unit configured to calculate a resultant force of axial forces based on the stress distribution and the damage indicator of the concrete fibers of the xth cross-section at the time t and the stress distribution and the damage indicator of the reinforcement fibers of the xth cross-section at the time t;
a determination unit configured to determine whether the resultant force of the axial forces is zero;
a first execution unit configured to, if the resultant force of the axial forces is zero, calculate and output the damage indicator and the bending moment-curvature curve of the xth cross-section at the time t; and
return to “setting a positon of a neutral axis of the xth cross-section at the time t as y_{0,x}(t)”.

6. (canceled)

7. The system for quantitative damage monitoring of a reinforced concrete structure according to claim 6, wherein the resultant force calculation unit comprises:
a resultant force calculation subunit configured to calculate the resultant force of the axial forces by the following formula:
$$\sum Nx ( t ) = {\sum }_{i = 1}^{n ( x )} ( 1 - {D}_{ci , x} ( {ε}_{ci , x} ( t ) ) ) {σ}_{ci , x} ( {ε}_{ci , x} ( t ) ) {A}_{c , i} + ( 1 - {D}_{s , x} ( {ε}_{s , x} ( t ) ) ) {σ}_{s , x} ( {ε}_{s , x} ( t ) ) {A}_{s} + ( 1 - {D}_{s , x} ( {ε}_{sc , x} ( t ) ) ) {σ}_{s , x} ( {ε}_{sc , x} ( t ) ) {A}_{s}^{′}$$
ΣNx(t)=, wherein ΣNx(t) represents the resultant force of the axial forces; D_{ci,x}(ε_{ci,x}(t)) represents a damage indicator of the ith concrete fiber of the xth cross-section at the time t, and D_{s,x}(ϵ_{s,x}(t)) represents a damage indicator of the compressive reinforcement fibers of the xth cross-section at the time t; D_{s,x}(ε_{s,x}(t)) represents a damage fiber of the tensile reinforcement fibers of the xth cross-section at the time t; A_{c,i}=(bh/n(x)) represents an area of the ith concrete fiber; b represents the cross-section width; h represents the cross-section height; Aₛ represents an area of the tensile reinforcement fibers; Aₛ′ represents an area of the compressive reinforcement fibers; σ_{s,x}(ε_{s,x}(t)) represents a stress distribution of the compressive reinforcement fibers of the xth cross-section at the time t; σ_{s,x}(ε_{s,x}(t)) represents the strain distribution of the tensile reinforcement fibers of the xth cross-section at the time t; σ_{ci,x}(ε_{ci,x}(t)) represents a stress of the ith concrete fiber in the xth cross-section at the time t; and n(x) represents a number of the concrete fibers in the xth cross-section.

8. The system for quantitative damage monitoring of a reinforced concrete structure according to claim 6, wherein the first execution unit comprises:
a damage indicator calculation subunit configured to calculate the damage indicator of the xth cross-section at the time t by a formula
$${D}_{sec , x} ( t ) = 1 - \frac{A - {B}^{2} / C}{{A}^{′} - {B}^{′2} / {C}^{′}} ,$$
wherein
$$A = {\sum }_{i = 1}^{n ( x )} ( 1 - {D}_{ci , x} ( {ε}_{ci , x} ( t ) ) ) {E}_{0} {A}_{c , i} {{y}_{i , x} ( t )}^{2} + ( 1 - {D}_{s , x} ( {ε}_{s , x} ( t ) ) ) {E}_{s} {A}_{s} ( d - {A}^{′} = {E}_{0} {A}_{c , i} {{y}_{i , x} ( t )}^{2} + {E}_{s} {{A}_{s} ( d - h + {y}_{0 , x} ( t ) )}^{2} + {E}_{s} {{A}_{s}^{′} ( h - {d}^{′} - {y}_{0 , x} ( t ) )}^{2} ,$$
$$B = {\sum }_{i = 1}^{n ( x )} ( 1 - {D}_{ci , x} ( {ε}_{ci , x} ( t ) ) ) {E}_{0} {A}_{c , i} {y}_{i , x} ( t ) + ( 1 - {D}_{s , x} ( {ε}_{s , x} ( t ) ) ) {E}_{s} {A}_{s} ( d - h + {y}_{0 , x} ( t ) ) + ( 1 - {D}_{s , x} ( {ε}_{sc , x} ( t ) ) ) {E}_{s} {A}_{s}^{′} ( h - {d}^{′} - {y}_{0 , x} ( t ) ) ,$$
$${B}^{′} = {E}_{0} {A}_{c , i} {y}_{i , x} ( t ) + {E}_{s} {A}_{s} ( d - h + {y}_{0 , x} ( t ) ) + {E}_{s} {A}_{s}^{′} ( h - {d}^{′} - {y}_{0 , x} ( t ) ) ,$$
$$C = {\sum }_{i = 1}^{n ( x )} ( 1 - {D}_{ci , x} ( {ε}_{ci , x} ( t ) ) ) {E}_{0} {A}_{c , i} + ( 1 - {D}_{s , x} ( {ε}_{s , x} ( t ) ) ) {E}_{s} {A}_{s} + ( 1 - {D}_{s , x} ( {ε}_{sc , x} ( t ) ) ) {E}_{s} {A}_{s}^{′} ,$$
$${C}^{′} = {\sum }_{i = 1}^{n ( x )} {E}_{0} {A}_{c , i} + {E}_{s} {A}_{s} + {E}_{s} {A}_{s}^{′} ;$$
D_{ci,x}(ε_{ci,x}(t)) represents the damage indicator of the ith concrete fiber of the xth cross-section at the time t; D_{s,x}(ε_{s,x}(t)) represents the damage indicator of the compressive reinforcement fibers of the xth cross-section at the time t; D_{s,x}(ε_{s,x}(t)) represents the damage indicator of the tensile reinforcement fibers of the xth cross-section at the time t; h represents the cross-section height; Aₛ represents the area of the tensile reinforcement fibers; Aₛ′ represents the area of the compressive reinforcement fibers; σ_{s,x}(ε_{s,x}(t)) represents the stress distribution of the compressive reinforcement fibers of the xth cross-section at the time t; σ_{s,x}(ε_{s,x}(t)) represents the strain distribution of the tensile reinforcement fibers of the xth cross-section at the time t; σ_{ci,x}(ε_{ci,x}(t)) represents the stress of the ith concrete fiber in the xth cross-section at the time t; E₀ represents the initial tangent modulus of concrete; d′ represents the protective layer thickness; Eₛ represents the initial tangent modulus of the reinforcement; A_{c,i} represents the area of the ith concrete fiber; n(x) represents the number of the concrete fibers in the xth cross-section;
a bending moment calculation subunit configured to calculate a bending moment Mx(t)=Mcx(t)+Msx(t) of the xth cross-section based on a sum of products of axial forces of the concrete fibers and distances of centers of the concrete fibers from the neutral axis y_{0,x}(t) and a sum of products of axial forces of the reinforcement fibers and distances of centers of the reinforcement fibers from the neutral axis y_{0,x}(t), wherein Mcx(t) represents a bending moment of the concrete fibers of the xth cross-section at the time t, Mcx(t)=y_{i,x}(t) represents a distance of a center of the ith concrete fiber in the xth cross-section at the time t from the neutral axis; and Msx(t) represents a bending moment of the xth cross-section at the time t,
$$Msx ( t ) = ( 1 - {D}_{s , x} ( {ε}_{s , x} ( t ) ) ) {σ}_{s , x} ( {ε}_{s , x} ( t ) ) {A}_{s} ( d - h + {y}_{0 , x} ( t ) ) + ( 1 - {D}_{s , x} ( {ε}_{sc , x} ( t ) ) ) {σ}_{s , x} ( {ε}_{sc , x} ( t ) ) {A}_{s}^{′} ( h - {d}^{′} - {y}_{0 , x} ( t ) ) ;$$
Msx(t)=; and
a curve plotting subunit configured to plot the bending moment-curvature curve based on the bending moment and the curvature.
